(19) United States
(12) Patent Application Publication
(10) Pub. No.: US 2010/0031135 A1
(43) Pub. Date: Feb. 4, 2010

(54) ANNOTATION MANAGEMENT IN ENTERPRISE APPLICATIONS

(75) Inventors: Rozita Naghshin, Verdun (CA); Thierry Bonfante, Montreal (CA); Warren Baird, Montreal (CA)

Correspondence Address: MARGER JOHNSON & MCCOLLOM, P.C. - Oracle;(ORACLE), 210 SW MORRISON STREET, SUITE 400, PORTLAND, OR, 97204, US

(73) Assignee: ORACLE INTERNATIONAL CORPORATION, Redwood Shores, CA (US)

(21) Appl. No.: 12/191,964

(22) Filed: Aug. 14, 2008

Related U.S. Application Data
(60) Provisional application No. 61/085,778, filed on Aug. 1, 2008.

(51) Int. Cl. G06F 17/00

(52) U.S. Cl. 715/230

(57) ABSTRACT

A computer-implemented method of managing collaboration in an enterprise application includes creating an annotation that corresponds to at least a first document and a second document, the first document having a first document format and the second document having a second document format. The computer-implemented method can further include mapping the annotation to a workflow process. An annotation management system includes multiple document repositories to store documents, an annotation repository to store annotations, wherein each annotation references a document stored in a corresponding document repository, and an annotation application to allow collaborators to view at least some of the annotations, allow at least one of the collaborators to search the annotations, and allow at least one of the collaborators to apply a filter to the annotations.

### CROSS-REFERENCE TO RELATED APPLICATIONS

This application claims the benefit of U.S. Provisional Application No. 61/085,778, filed Aug. 1, 2008, which is hereby incorporated by reference in its entirety.

### BACKGROUND

The exchanging of ideas forms an important if not essential part of any collaborative activity, and the productivity of a team often depends upon it. Many large global corporations face managing multi-disciplinary collaboration as one of the main challenges. Generally in any large enterprise, various collaborators from diverse disciplines examine, discuss, and revise hundreds of documents in different formats as part of their daily job functions. This process regularly produces significantly large amounts of data in various forms of digital annotation and markup, hand-written comments and annotations, emails, memos, chats, voice mail, images, etc. The data is often fragmented across the enterprise and stored in a wide variety of repositories, and currently no single effective solution for retrieving or managing such data exists.

Many of the current solutions have the ability to support only a limited number of formats, and often only a single format. An enterprise collaboration process results in documents processed in different formats such as 2D Computer Assisted Design (CAD), 3D CAD, and Electronic Computer Assisted Design (ECAD), textual documents, emails, and images. Collaborators and reviewers use different software solutions that normally do not talk to each other.

In a typical large enterprise, different repositories and enterprise back-end systems such as Enterprise Resource Planning (ERP), Customer Relationship Management (CRM), Product Lifecycle Management (PLM), and Supply Chain Management (SCM), routinely store documents. Email applications and local individual user PCs also store documents. However, existing products cannot easily integrate into such systems and none of them support multiple back-end systems.

Current software applications that support annotation and markup do not model and visualize annotations correctly based on a user's mental model of an annotation, which makes annotations difficult to understand, especially since collaborators often have come from different educational and/or cultural backgrounds.

In addition, current annotation solutions are document-centric, meaning that annotations bind with individual documents. In the real world, a single annotation may include multiple documents of different formats.

These and other limitations make it very difficult to retrieve and manage user annotations and map them to the pertinent workflow process, as well as integrating into back-end systems. These and other disadvantages of previous systems make collaboration considerably longer and frequently result in misunderstandings among different disciplines as well as inconsistency in the end product.

### BRIEF DESCRIPTION OF THE DRAWINGS

FIG. 1 shows an example of a multiple-system arrangement utilizing a centralized integration of annotations.

FIG. 2 shows an example of an annotation class diagram.

FIG. 3 shows an example of creating annotations.

FIGS. 4-6 show an example of grouping multiple entities while creating an annotation.

FIG. 7 shows an example of adding one or more contexts to an annotation from different documents.

FIGS. 8-11 show a detailed example of adding one or more contexts to a particular annotation from different documents.

FIG. 12 shows an example of an activity diagram illustrating annotation publishing and locking features.

FIG. 13 shows an example of adding an annotation to a list.

FIG. 14 shows an example of threaded comments.

FIG. 15 shows an example of a context identifier.

FIG. 16 shows an example of a context identifier targeting multiple files of different formats.

FIGS. 17 and 18 show an example of an integration of annotations into an enterprise system.

### DETAILED DESCRIPTION

In all collaborative activities, team members should work on a clearly-defined context. The context of collaboration generally includes goals, scope of the projects, products, team members' discussions, and the like, which usually exist in a number of forms such as face to face discussions, documents of different formats, graphs, emails, voicemail, pages on the internet, memos, etc. The context is typically the core part of any collaboration and team discussion, and the quality of the end product usually depends on each team-member's ability to grasp it. Therefore, one of the most important challenges is to provide all team members with an understandable representation of the context.

In order to understand a context, team members from multiple disciplines should be able to view multiple documents of different formats that are usually stored in multiple backend systems. Moreover, understanding a context typically depends on understanding the connections and relationships between its elements. If a collaborator cannot clearly view these connections, for example, the context can easily be misinterpreted, which will often lead to misunderstanding and conflict between team members. In software technology and “contextual collaboration,” there have been several attempts to represent the context. However, none of them have been complete or successful.

One way to make the context more understandable is to add digital annotations to the documents. However, current annotations are document-centric, meaning that annotations bind with individual documents. Since the elements of a context can exist in different forms stored in several documents, current annotations can not visualize the context correctly.

Another attempt is creating portals, which involves embedding all the relevant applications, such as word processors, enterprise instant messaging (EIM), shared calendars, and groupware, into a unified user interface. Using portals may make retrieving information faster and easier, but it does not visualize the relationship between all elements, meaning that team members must still find their own way through represented information in order to have a correct mental model of a context. The portal acts more as visual glue around fragmented and heterogeneous information than as a real way to represent a complete collaboration context.

The disclosed technology, unlike previous attempts, provides various new and advantageous techniques to not only visualize the data related to the context of a collaboration, but the relationships between its elements. In various implementations, multiple team members can create connections between multiple elements of different forms that are stored in multiple repositories. Because these annotations are typically external, the collaborators can view annotations independently, from any repository or collaborative environment. Thus, implementations can greatly facilitate collaboration and communication in virtually any enterprise. An example of a software application utility that may embody the advantageous techniques discussed herein will be referred to as AutoVue Annotation.

An annotation generally represents a thread of comments in a context and is typically stored as a standalone, separate entity. The annotation can desirably include threaded comments and context identifiers. A threaded comment generally includes a thread of one or several comments in the form of text and/or image added to one or more documents that represent the exchange of ideas between one or multiple participants. Context identifiers generally refer to graphical elements that allow participants to identify the subject of comments based on visual common sense or workplace convention. For example, an identifier could highlight a region of a document, or an empty identifier could mean that the annotation applies to the whole document or simply to the current page. The context identifier can target a part of a file, a whole file, parts of multiple files, or multiple whole files of virtually any format.

Using implementations of AutoVue Annotation, users can advantageously create annotations to documents of various different formats, including but not limited to 2D and 3D drawings, ECAD files, and office documents. Moreover, users can create an annotation that covers multiple files of different formats. For example, a user can create an annotation with the text “this chip will not fit within the provided case” and also point to a dimension of a PCB design, a dimension of a 3D model, and a certain paragraph in a requirement document indicating the correct size to be used.

The generated annotations can be advantageously leveraged throughout the enterprise processes and systems as the entities representing the context of a specific collaboration activity.

Developers usually view annotations as metadata, as they give additional information about an existing piece of data. One or more annotation servers or local storage may store annotations. When a user browses a collaborative project, for example, the browser typically sends a query or group of queries to the annotation servers to request all of the annotations related to a document or a project.

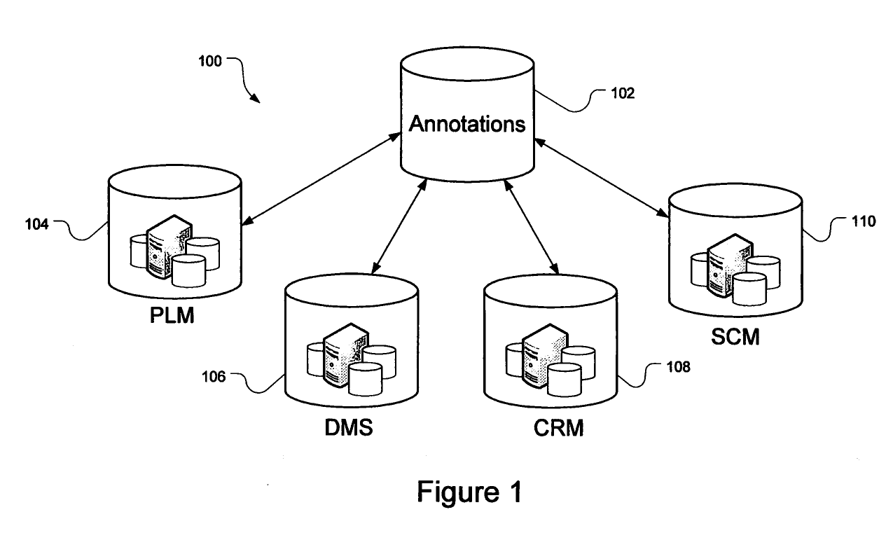

As discussed above, annotations are typically external and can be stored independent of the documents to which they apply. FIG. 1 illustrates example of a multiple-system arrangement 100 utilizing a centralized integration of annotations 102 (e.g., stored in a database). By integrating the annotations 102 to multiple middleware and backend systems such as a Product Lifecycle Management (PLM) system 104, a Document Management System (DMS) 106, a Customer Relationship Management (CRM) system 108, and a Supply Chain Management (SCM) system 110, the system can map related data to different workflow processes and effectively and efficiently monitor collaborative activities. For example, a collaborator can view a list of some or all of the annotations related to a particular collaborative activity or activities from virtually any portal. The collaborator can search the annotations 102, apply a filter to the annotations 102, or reply to one or more of the annotations 102.

In certain embodiments, annotations can be created as dynamic objects for use as part of a collaborative process. Collaborators can view annotations of multiple documents from a centric repository, search them, and filter them. The collaborators can add tags to annotations, apply at least one status to one or more of the annotations, or reply to the annotations. The collaborators can keep the track of some or all of the pertinent annotations at any given time in a workflow process. For example, the users can check on the number of critical annotations and quickly and easily determine how many of the critical annotations have been resolved.

An annotation can represent a thread of comments in context. The annotation can include threaded comments and context identifiers. A threaded comment generally includes a thread of one or several comments in the form of text and/or image added to one or more documents that represent the exchange of ideas between one or multiple participants. Context identifiers generally refer to graphical elements that allow participants to identify the subject of comments based on visual common sense or workplace convention. For example, an identifier could highlight a region of a document or an empty identifier could mean that the annotation applies to the whole document or simply to the current page. The context identifier can target a part of a file, a whole file, parts of multiple files, or multiple whole files of virtually any format that is supported by AutoVue.

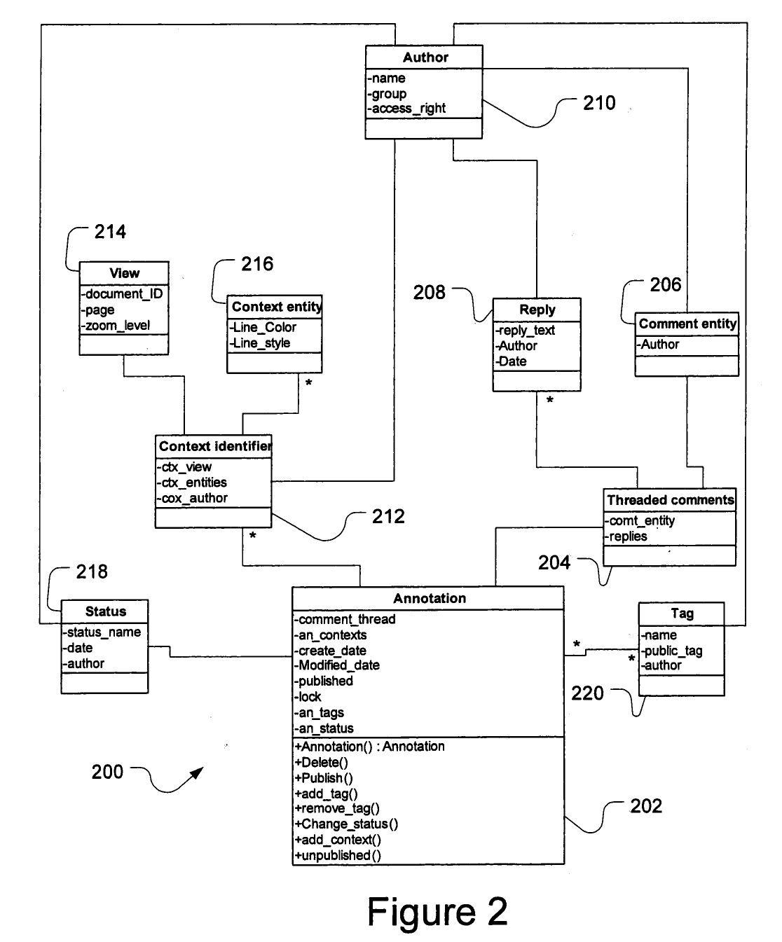

FIG. 2 shows an annotation class diagram 200. In this embodiment, an annotation 202 includes two main parts: threaded comments 204 and context identifiers 212. Each of the threaded comments 204 includes an associated comment entity 206, which can be in the form of text and/or image. Each of the threaded comments 204 also includes one or more corresponding replies 208 that are created by other authors 210 (e.g., collaborators).

In this example, the context identifiers 212 consist of graphical elements that allow participants to identify the subject of the comments based on visual common sense or workplace convention. For example, one of the context identifiers 212 could highlight a region of a document using a rectangle. The annotation 202 has several context identifiers 212 added to different documents. Each of the context identifiers has an associated view 214 that specifies the visual representation of the context including the zoom level, the camera angle and so on.

The annotation 202 may also have at least one status 218 and one or more tags 220 that are created by collaborators. The annotation 202 can be published or unpublished, and it can also be locked or unlocked. These and other attributes are described in greater detail below.

In certain embodiments, a user can create an annotation by initiating a threaded comment and pointing it to the context using one or more context identifiers. While creating an annotation, an exemplary system can automatically group annotation entities in the form of the threaded comments and its context identifier, for example. This grouping can be based on user interactions while creating or modifying annotations, providing users with the capability to map review information properly into the pertinent workflow process. The annotations become dynamic objects that can advantageously reflect the current status (and/or a past status) of the review process at any given time. Also, a participant (e.g., collaborator) can add and/or modify a context identifier manually.

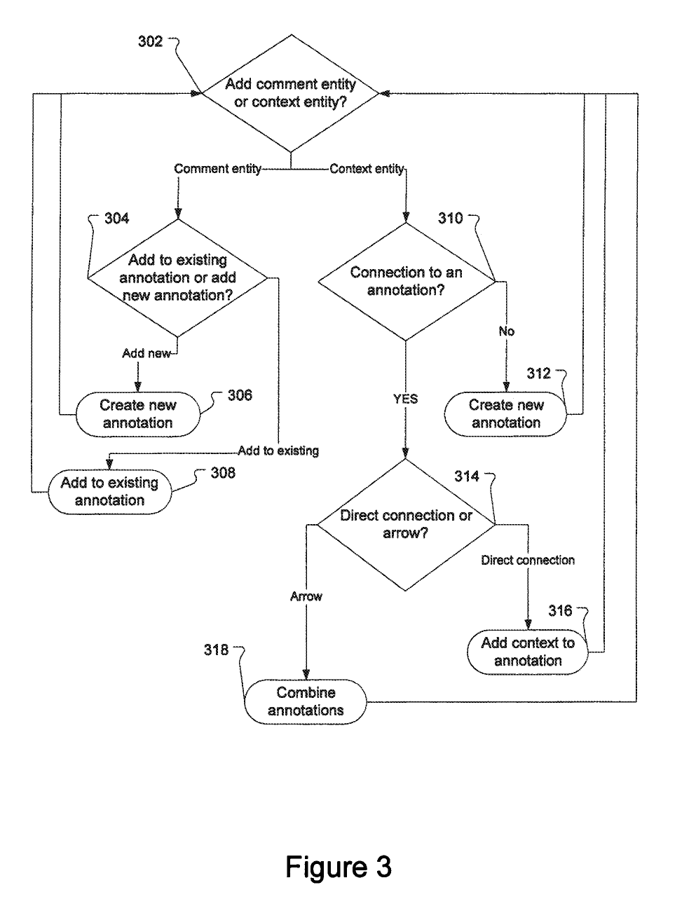

FIG. 3 shows a flowchart illustrating an embodiment of a computer-implemented method 300 of creating one or more annotations. A user can begin by first deciding at 302 whether to add a comment entity or a context entity. If the user decides to begin by adding a comment entity, the user or system must then decide at 304 whether to create a new annotation or add to an existing annotation. If the user adds a comment that is not connected to anything, for example, the system can create a new annotation to which it will attach the new comment. Any existing annotations may or may not be empty annotations. Also, a user will generally not receive this option unless a connection to the existing annotation or annotations exists. After allowing a user to either create a new annotation at 306 or add to an existing annotation at 308, the system then returns the user to 302.

If the user decides at 302 to add a context entity, the system must determine at 310 whether a connection exists to an annotation. If the system determines that no such connection exists, a new annotation is advantageously created. Also, the user can decide to create a new annotation at 312. After allowing the user to create the new annotation, the system returns the user to 302.

If the system determines at 310 that at least one connection to one or more existing annotations exists, the system must then determine at 314 whether the connection is a direct connection to an annotation or an arrow that connects an empty connotation to a comment. If the system determines that the connection is a direct connection to an annotation, then the system allows the user at 316 to add the context to the annotation and then generally returns the user to 302. Otherwise, the system typically combines annotations at 318 and returns the user to 302. The combination at 318 can be performed automatically or in response to user input.

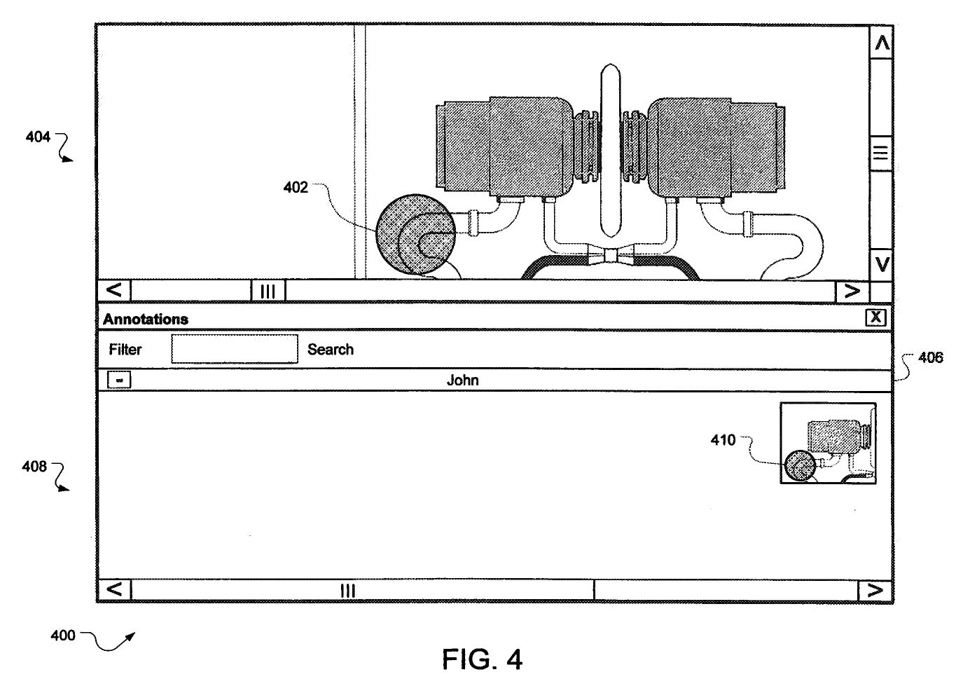

FIGS. 4-6 are simulated screenshots 400-600, respectively, that together illustrate a technique that focuses on the grouping of multiple entities (e.g., graphical and text elements) during the creation of an annotation, here shown as having a text box, an arrow, and a circle. In the example, the grouping includes first creating an empty annotation, then creating a second annotation, and finally combining the multiple annotations. In some implementations, the system may perform such grouping automatically.

In this scenario, a user first draws (or otherwise places or causes to be placed) a circle 402 in a workspace area 404, as illustrated in the screenshot 400 of FIG. 4. In the example, the circle 402 comprises a context entity. In response to the user drawing the circle 402 in the workspace area 404, AutoVue desirably generates a first annotation 406 that is displayed in the annotations area 408. The first annotation 406 starts as an empty annotation, which here simply denotes that the first annotation 406 does not yet have a comment entity.

The circle 402 that was drawn by the user in the workspace area 404 is represented by a smaller circle 410 displayed in connection with the first annotation 406. One of skill in the art will recognize, however, that representations displayed in the annotations area 408 (e.g., the smaller circle 406) of corresponding items in the workspace area 404 (e.g., the circle 402) do not necessarily differ in size, shape, or appearance.

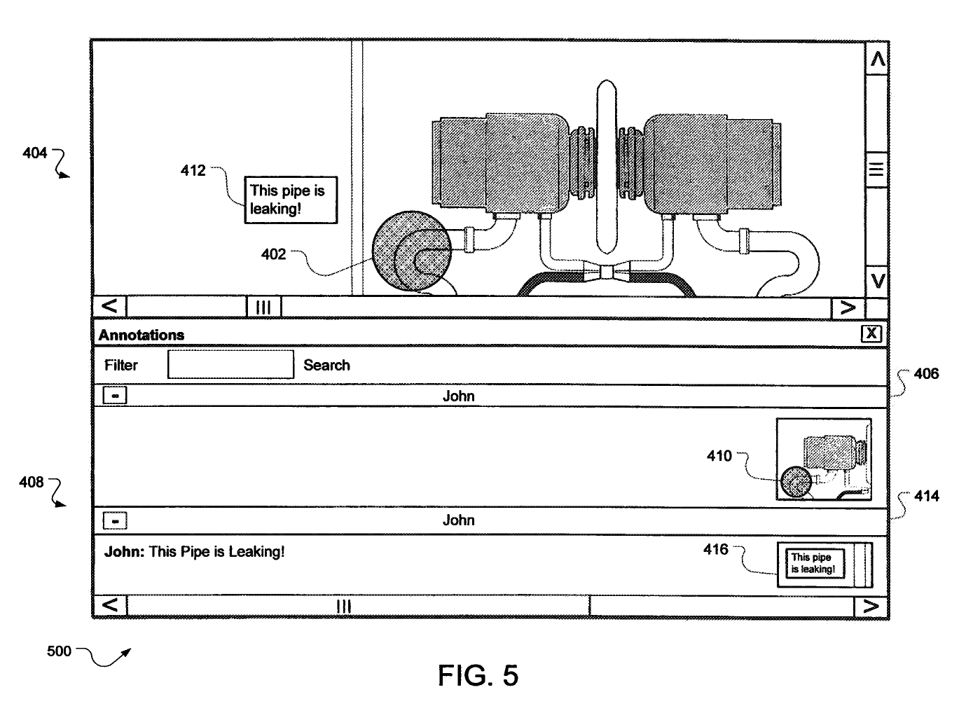

The user adds (or otherwise places or causes to be placed) a text box 412 in the workspace area 404, as illustrated in the screenshot 500 of FIG. 5. The text box 412 contains text indicating that the pipe in the schematic diagram (indicated by the circle 402) is leaking. In the example, the text box 412 consists of a comment entity that initially has no connection to the circle 402. In response to the user adding the text box 406 in the workspace area 404, AutoVue generates a second annotation 414 displayed with the first annotation 406 in the annotations area 408. The text box 416 displayed in connection with the second annotation 414 represents the text box 412 that was placed by the user in the workspace area 404.

In the example, the system displays the second annotation 414 adjacent to and immediately below the first annotation 406 in the annotations area 408. It will be recognized by one of skill in the art that multiple annotations can be displayed in the annotations area 408 in a variety of different ways and that such arrangements are not in any way limited by the particular arrangement shown in the screenshot 500.

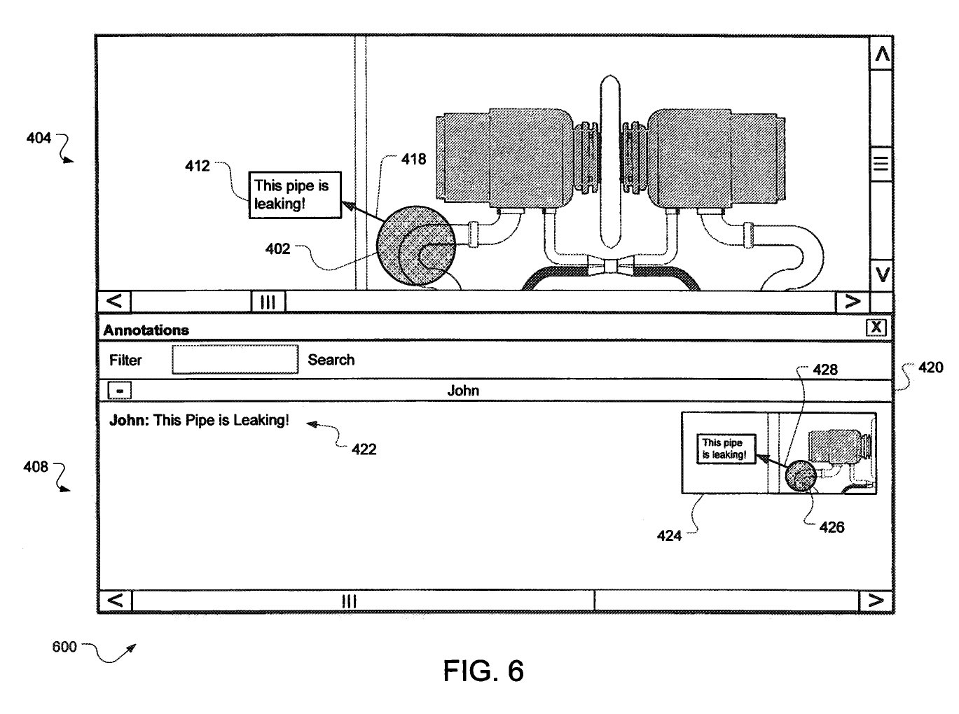

The user now adds (or otherwise places or causes to be placed) an arrow 418 in the workspace 404, as illustrated in the screenshot 600 of FIG. 6. The arrow 418 connects the circle 402 with the text box 412 in the workspace 404. In response to the addition of the arrow 418, AutoVue combines the first annotation 406 with the second annotation 414 into a new annotation 420 that replaces the first annotation 406 and the second annotation 414 in the annotations area 408. The new annotation 420 includes the text from the text box 412 as a comment 422 and also has a context identifier 424 containing a representation 426 of the circle 402 as well as a representation 428 of the arrow 418. In the example, the comment 422 indicates user “John” as being responsible for the text.

In certain embodiments, the system can apply an annotation to multiple documents. In previous systems, all annotations were associated with a single file, increasing redundancy and complexity in managing the review process while decreasing user understandability in the collaboration. In certain implementations of the techniques described herein, however, the context of one or more annotations can be associated with multiple files, making it easier for a user (e.g., a collaborator) to understand and manage the annotations.

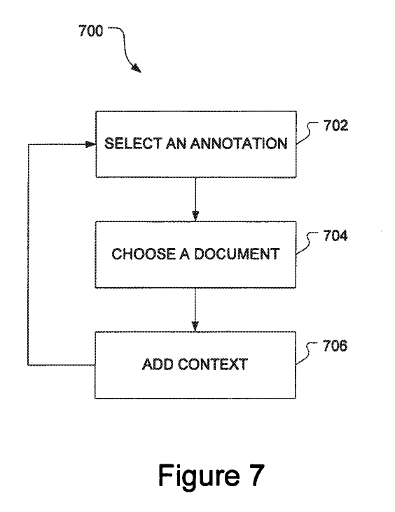

A given context of a corresponding annotation does not necessary connect to threaded comments. In fact, a context of an annotation may spread into multiple pages or multiple documents. FIG. 7 illustrates a computer-implemented method 700 demonstrating how the system provides a user with the ability to add one or more contexts to a particular annotation from different documents.

In the example, a user first selects a particular annotation at 702 (e.g., using a “Select Annotation” option via a user interface). If the system approves the selection (e.g., “annotation.lock” has a null value), the system can then present a dialogue box to the user.

The user then chooses a particular document from the dialogue box at 704. For example, the user can select the document from a list of documents that may or may not be available for selection by the user. If the system approves the selection, the system can then open the selected document in a separate window.

Finally, the user adds the context at 706. In certain embodiments, the user will create a new context entity (e.g., in response to a prompt by the system) to be added to the annotation. In other embodiments, the user will select an existing context entity to be added to the annotation. Once the context has been added at 706, the system returns the user to the initial step 702 of the method 700.

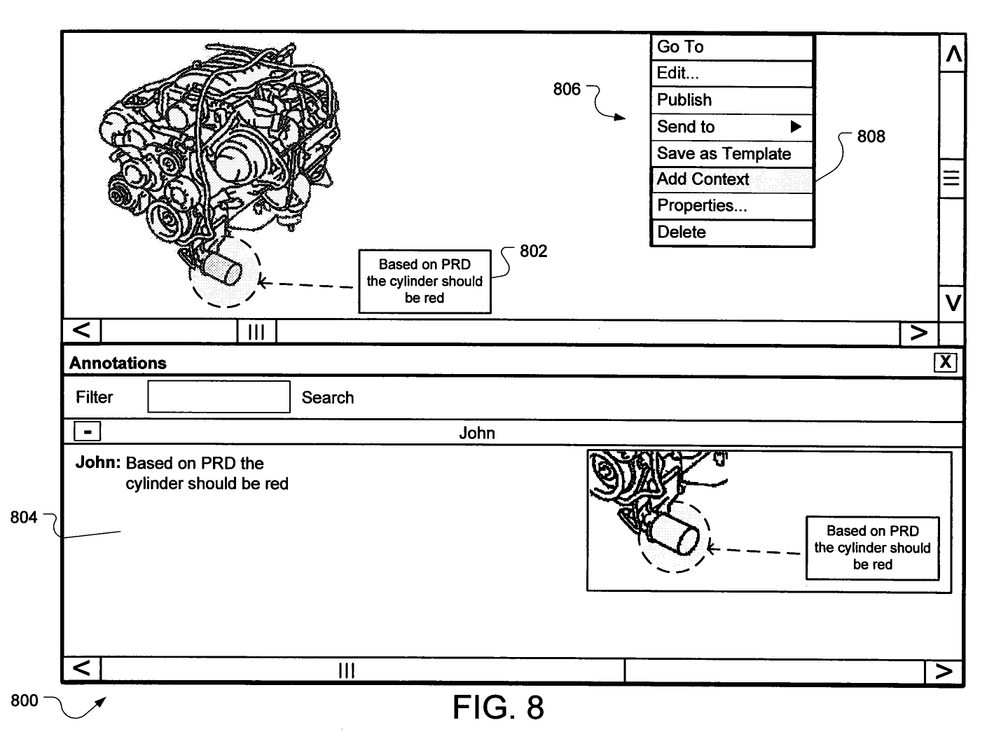

FIGS. 8-11 are simulated screenshots 800-1100, respectively, that together illustrate a technique that focuses on allowing a user to add one or more contexts to a particular annotation (e.g., an annotation selected by a user).

In the example, a user first performs a right-click operation on a text box 802, as illustrated in the screenshot 800 of FIG. 8. The text box 802 corresponds to a particular annotation 804 which, in the example, is the annotation to which the user desires to add a context. In response to the right-click operation, the system displays a right-click menu 806. One of the options in the right-click menu 806 is an “Add Context” option 808, which the user selects (as indicated by the shading as well as the location of the cursor, which is pointing to the “Add Context” option 808. One of skill in the art will appreciate that, while the illustrated example includes a right-click menu, various other methods may be employed to allow the user to invoke or otherwise select an “Add Context” or similar operation.

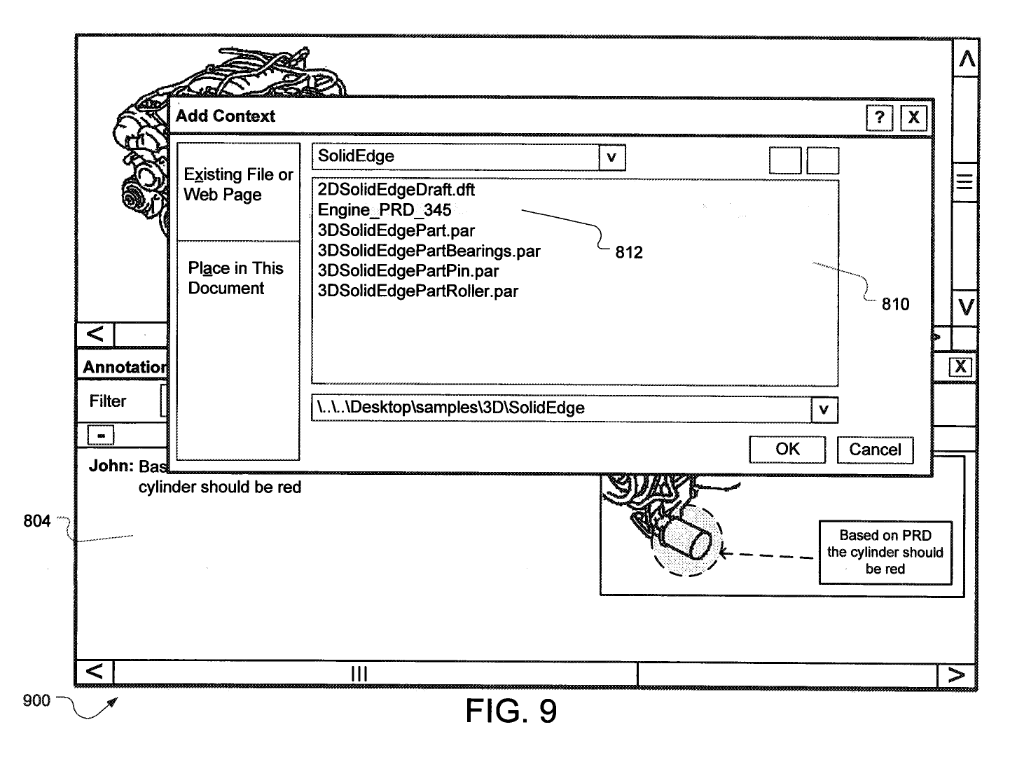

In response to the user selecting the “Add Context” option 808, the system opens and presents to the user a dialog box 810, as illustrated in the screenshot 900 of FIG. 9. Using the dialog box 810, the user can select a desired document 812 to be opened in a separate window. In the present example, the desired document 812 is named “Engine_PRD_{—}345.”

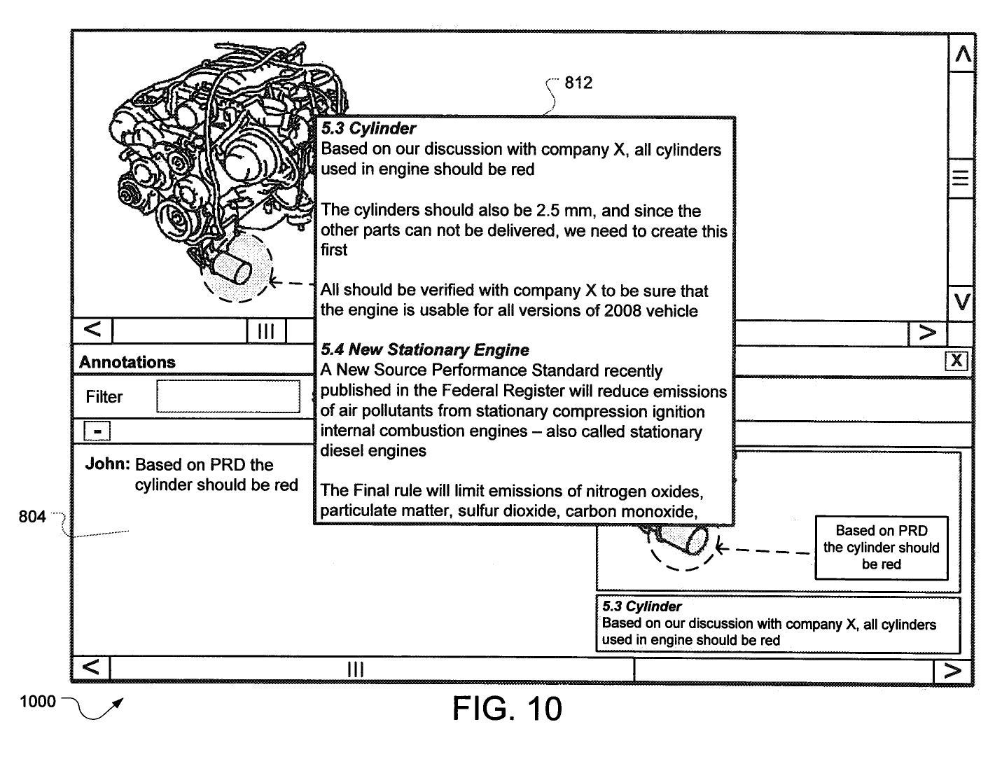

The system opens the selected document 812 in a separate window, as illustrated in the screenshot 1000 of FIG. 10. The system allows the user to select or create a context identifier. In the present example, the context identifier includes certain text 814 that has been highlighted in the document 812.

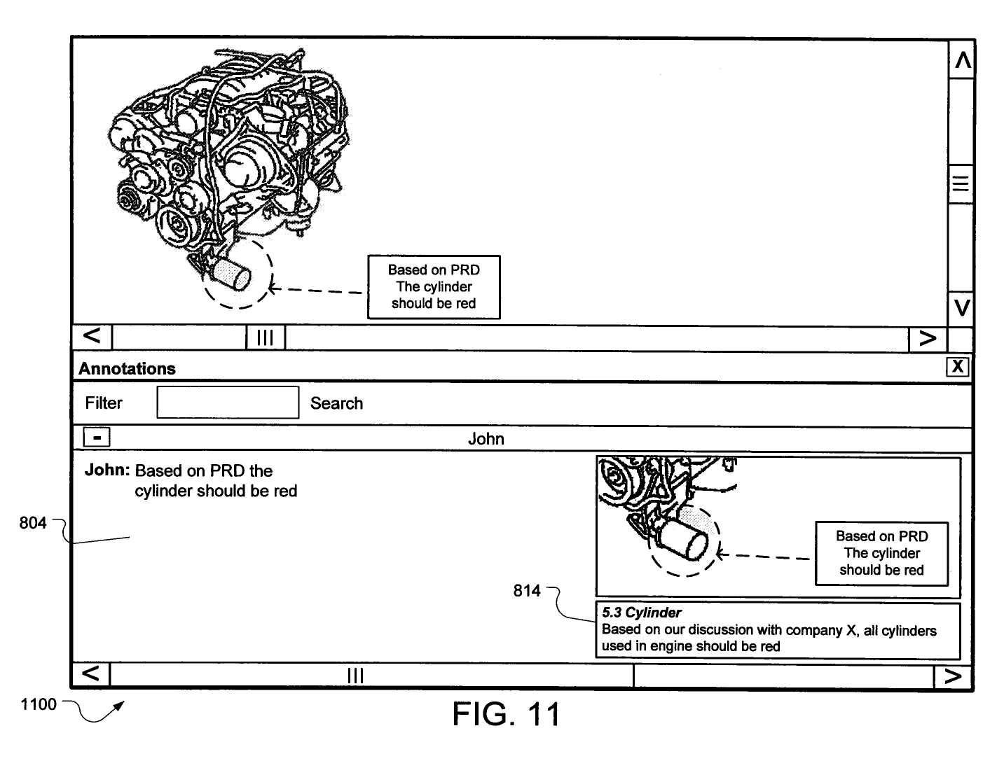

After the user closes the second window displaying the document 812, the system shows that the new context 814 has been added to the annotation 804 by displaying the context 814 in connection with the annotation 804, as illustrated in the screenshot 1100 of FIG. 11.

Publishing and locking are two concepts that can be used in implementations of the disclosed technology in order to control collaboration over annotations. For example, annotations can be automatically saved as they are created. Initially they are generally unpublished, though, which means that only the author of the annotations is provided with the ability to see the annotations. In this state, the author is also allowed to modify or delete any or all of the annotations.

Once a user (typically the author) publishes an annotation, other collaborators can view the published annotation. The published annotation is still unlocked, however, which means that the author continues to retain the ability to modify or unpublish the annotation. However, as soon as another collaborator replies to an annotation, changes the annotation's status, or uses the annotation as a context of another annotation, the annotation becomes locked and neither the designated user (e.g., author) nor any other user can modify or unpublish the annotation.

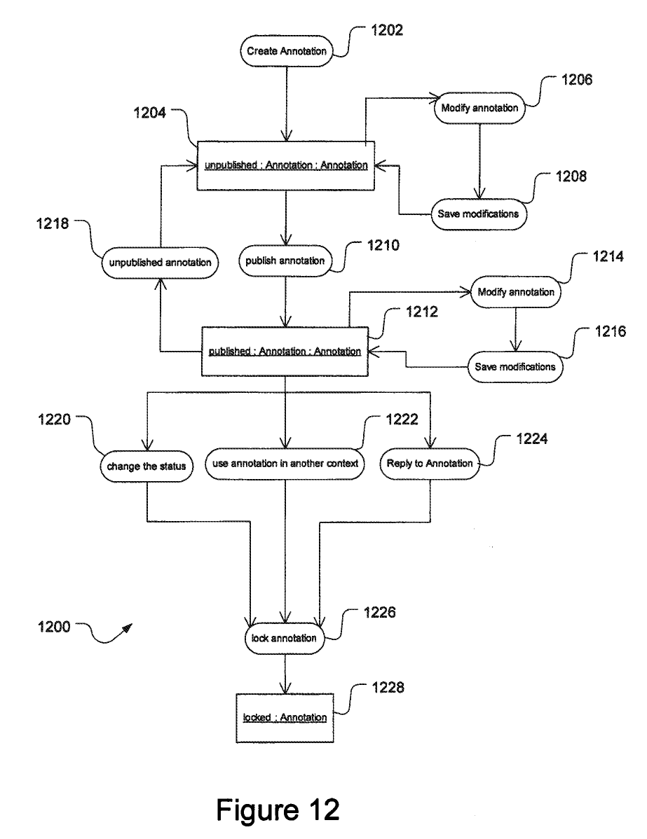

FIG. 12 shows an activity diagram 1200 of publishing and locking that includes adding an annotation to a given list and making its contexts visible for a specific user. A user first creates an annotation at 1202 in accordance with any of the annotation creation techniques discussed here. The annotation is initially unpublished, as indicated at 1204. At this point, the user is presented with an option to modify the annotation. In the example, the user modifies the annotation at 1206, and the modifications are then saved at 1208 before the process returns to 1204.

The user then decides to publish the annotation and does so at 1210. For example, the user can select a “Publish Annotation” option from a drop-down menu or click on a “publish annotation” desktop icon or toolbar button. The system publishes the annotation responsive to the user's action at 1210. A status of the annotation is then changed to “published,” as indicated at 1212. While the author of an annotation is typically the only user permitted to publish the annotation, other users could be granted such permission as well.

Once the annotation is indicated as being published at 1212, the user has several different options he or she can choose. For example, the user (e.g., any of the collaborators) can change a status of the annotation at 1220, use the annotation in another context at 1222, or reply to the annotation at 1224. After selecting any of these options, the process then moves along to 1226, at which point the annotation can be locked (e.g., automatically or responsive to user or other input). Once the annotation is locked at 1226, a status for the annotation is changed to “locked,” as indicated at 1228.

One of the various advantages of the techniques described here is that annotations can be centralized in a backend system. Such an arrangement allows collaborators to see a list of any or all annotations related to a particular project from virtually any backend system.

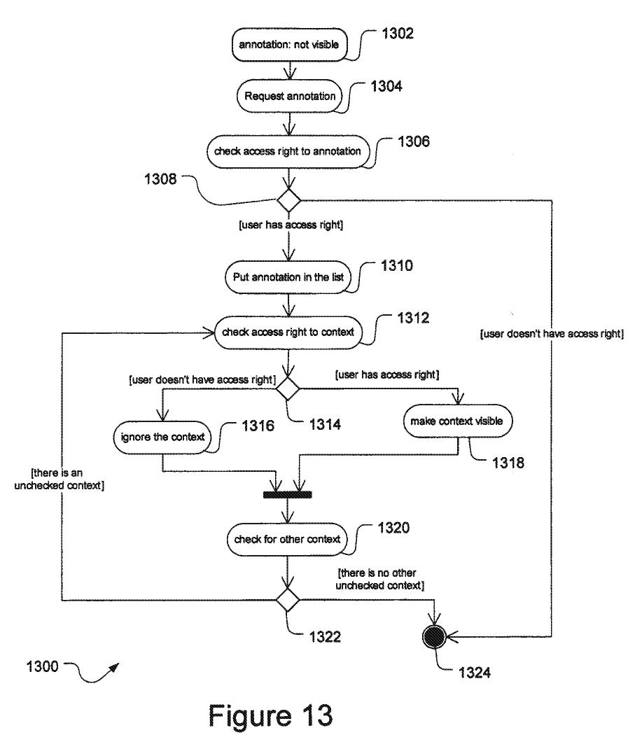

FIG. 13 shows an activity diagram 1300 relating to a method involving the addition of an annotation to a list. Initially, an annotation is indicated as being not visible, as indicated at 1302. The user then requests the annotation at 1304 (e.g., providing input through a user interface indicating the request). At 1306, the system is instructed to check the user's access right regarding the annotation and performs the determination at 1308. If the system determines that the user does not have access rights to the annotation, processing terminates, as indicated at 1324. However, if the system determines that the user does have access rights, the annotation is added to the list (e.g., the list to which the user wishes to add the annotation), as indicated at 1310.

At 1312, another determination is made regarding access rights, but this time the system checks whether the user has any access rights to a particular context for the annotation (e.g., the earliest context, the most recent context, a certain user-identified context, a context based on certain other criteria, etc.). If the system determines that the user does not have such access rights, the pertinent context is ignored (as indicated at 1316) and the process continues to 1320. If, however, the system determines that the user does have context access rights, the context is made visible to the user (e.g., displayed on the user's screen), as indicated at 1318.

In the example, the system is instructed to make a final determination at 1322 and does so at 1324. Specifically, the system checks for any other remaining context at 1324. If the system determines that no other context exists or is unable to locate any remaining contexts, processing terminates at 1324. If there is at least one more unchecked context, however, processing returns to 1312, where the system is instructed to check whether the user has any access rights to the newly-identified context.

In implementations of an annotation and workflow process in accordance with the disclosed technology, users can add different tags to annotations and also filter annotations based on a particular tag or tags. Moreover, each annotation typically has a status that can be defined by an administrator and changed by collaborators. For example, a designer (e.g., a collaborator) can open an annotation explaining a problem in a design and, once the problem has been resolved, the designer can close the annotation. Other users can thus monitor the status of a collaborative activity by looking at a dashboard that reflexes these statuses at any given time. For example, a supervisory user (e.g., a manager) can easily and readily see how many issues are still open and need to be resolved, if there is any critical problem.

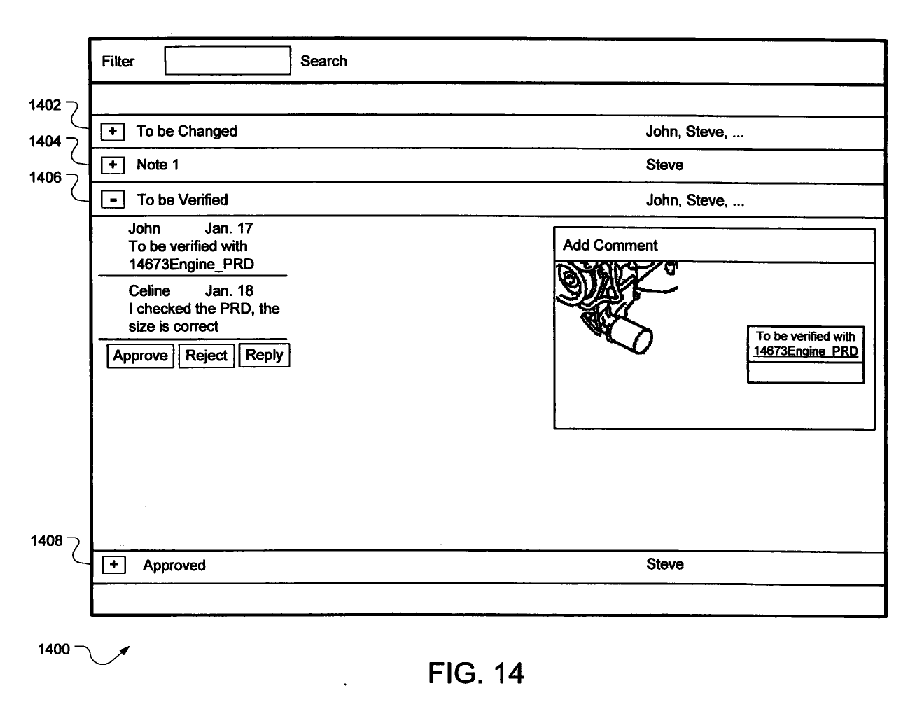

A threaded comment generally consists of a thread of one or more comments in the form of text and/or image that are added to one or more documents and represent the exchange of ideas between multiple participants. An example of threaded comments 1402-1408 is illustrated in a simulated screenshot 1400 shown in FIG. 14. The threaded comment 1406 titled “To be Verified” includes an initial comment by user “John” indicating information pertaining to verification of a certain component or sub-combination of a design. The threaded comment 1406 also includes a follow-up comment by user “Celine” that provides further information.

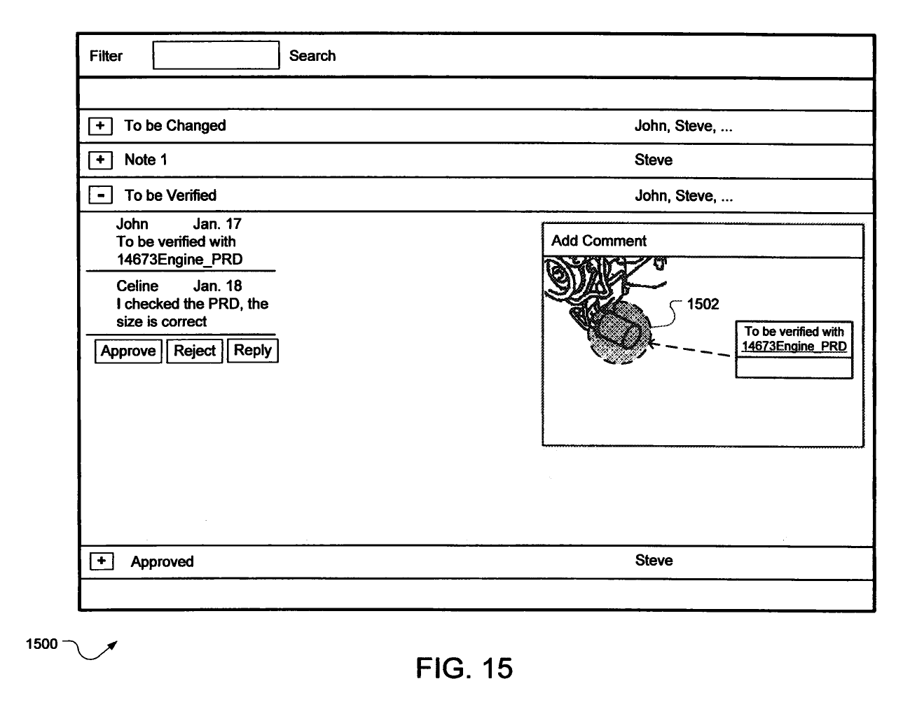

A context identifier generally includes one or more graphical elements that allow participants to identify a pertinent subject of the comment or comments in a thread based at least in part on visual common sense or workplace convention. An example of a context identifier 1502 is illustrated in a simulated screenshot 1500 shown in FIG. 15. Here, the context identifier 1502 includes a circle and an arrow indicating the component or sub-combination that user “John” commented on as discussed above with respect to FIG. 14. In the example, the component is a cylinder.

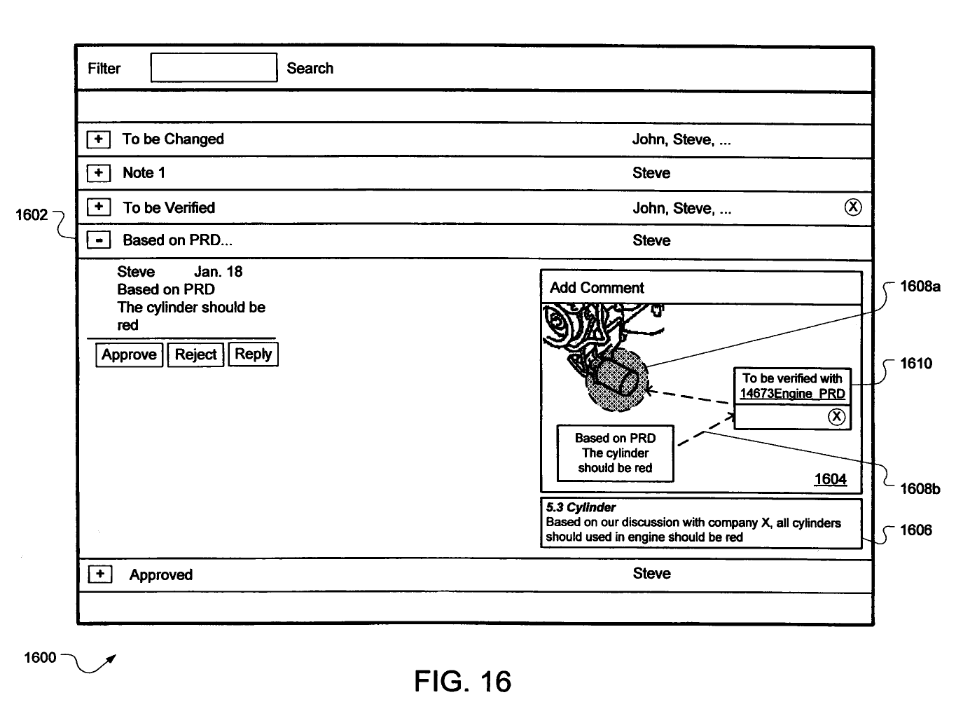

Previous annotation applications are undesirably document-centric, meaning that a single annotation cannot involve multiple documents regardless of type. In implementations of the disclosed technology, however, a context identifier can target multiple files of virtually any format (e.g., any format that AutoVue supports). An example of a context identifier 1608 targeting multiple files 1604 and 1606 (of different file types) is illustrated in a simulated screenshot 1600 shown in FIG. 16. An annotation 1602 titled “Based on PRD . . . ” by user “Steve” correlates multiple files referenced by 1604 and 1606. A context identifier 1608 targets both a previous comment 1610 (as indicated by 1608a) and the pertinent component (here, a cylinder) of the design in question (as indicated by 1608b).

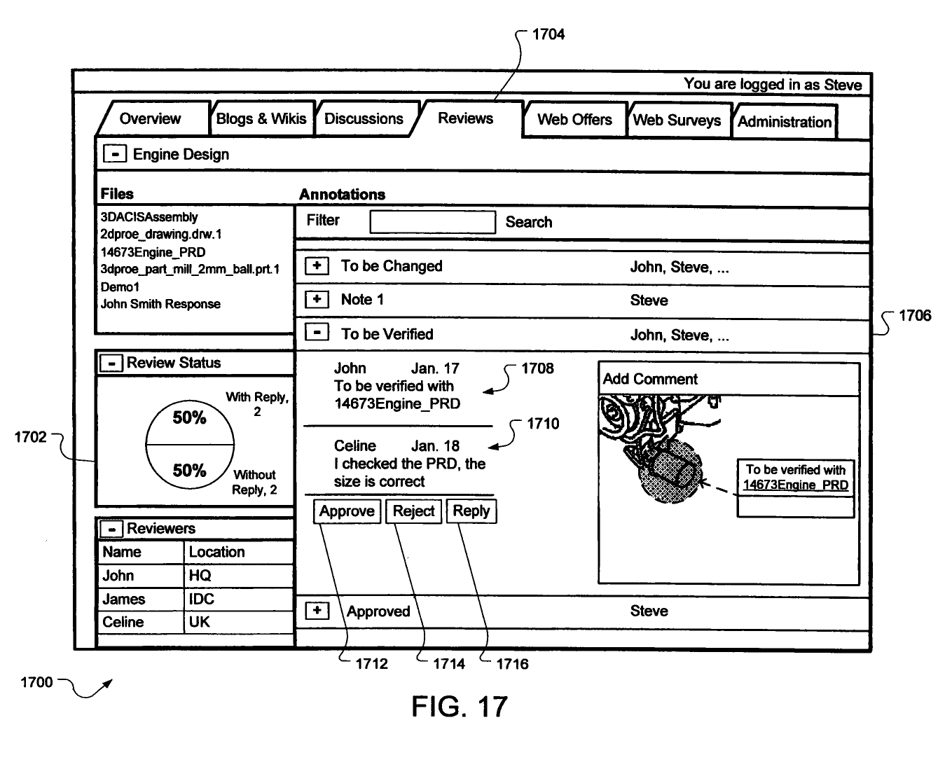

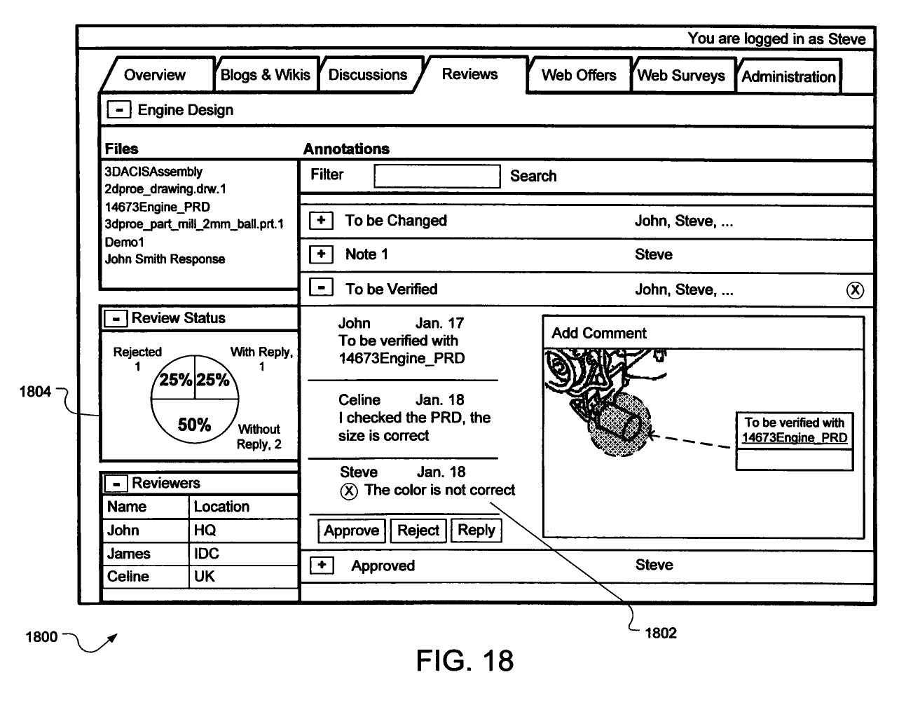

Annotations as described here are typically dynamic objects that can readily reflect a status of a review process at any given time. FIGS. 17 and 18 show simulated screenshots 1700 and 1800, respectively, that illustrate an exemplary implementation of annotations into an enterprise system in accordance with the disclosed technology.

The screenshot 1700 of FIG. 17 illustrates an embodiment of a web center having a dashboard 1702 that provides information pertaining to the status of a review process. Within the Reviews tab 1704 are multiple annotations such as the annotation 1706 title “To be Verified” having an initial comment 1708 by user “John” and a follow-up comment 1710 by user “Celine.” A user can Approve, Reject, or Reply to the latest comment (here, Celine's comment) using one of the buttons 1712, 1714, and 1716, respectively, provided in connection with “Celine's” comment 1710.

In embodiments of the disclosed technology, a user can take direct action with respect to an annotation directly from the web center. For example, the screenshot 1800 of FIG. 18 shows a comment 1802 by a user “Steve” indicating that Steve has rejected the previous comment by Celine. Responsive to Steve's comment 1802 rejecting Celine's comment, the dashboard 1804 indicates that the review status has changed (e.g., the number of annotations with reply has been reduced to one while the number of annotations rejected has increase from none to one).

The computer-implemented techniques described here provide various advantages, such as facilitating communication and improving the productivity of virtually any collaborative activities in a large enterprise. Using the disclosed techniques, participants of different workflow processes can effectively and efficiently collaborate on multiple documents of virtually any format. These techniques provide an effective solution for centralization and management of collaboration data that is often segmented as a result of being produced by multiple teams during different phases. This collaboration data then can be desirably mapped to different workflow processes.

The following discussion is intended to provide a brief, general description of a suitable machine in which certain aspects of the disclosed technology can be implemented. Typically, the machine includes a system bus to which are attached processors, memory, (e.g., random access memory (RAM), read-only memory (ROM), or other state-preserving medium), storage devices, a video interface, and input/output interface ports. The machine can be controlled, at least in part, by input from conventional input devices such as keyboards, mice, etc., as well as by directives received from another machine, interaction with a virtual reality (VR) environment, biometric feedback, or other input signal. As used here, the term “machine” is intended to broadly encompass a single machine, or a system of communicatively coupled machines or devices operating together. Exemplary machines include computing devices such as personal computers, workstations, servers, portable computers, handheld devices, telephones, tablets, etc.

The various advantageous techniques described here may be implemented as computer-implemented methods. Additionally, they may be implemented as instructions stored on a tangible computer-readable medium that, when executed, cause a computer to perform the associated methods. Examples of tangible computer-readable media include, but are not limited to, disks (e.g., floppy disks, rigid magnetic disks, and optical disks), drives (e.g., hard disk drives), semiconductor or solid state memory (e.g., RAM and ROM), and various other types of tangible recordable media such as CD-ROM, DVD-ROM, and magnetic tape devices.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an embodiment of the invention” or the like are used here, these phrases are meant to generally reference embodiment possibilities, and are not intended to limit the invention to particular embodiment configurations. As used here, these terms may reference the same or different embodiments that are combinable into other embodiments.

In view of the wide variety of permutations to the described embodiments, this detailed description is intended to be illustrative only and should not be taken as limiting the scope of the claims. What is claimed as the invention is all such modifications as may come within the scope and spirit of the following claims and equivalents thereto.

We claim:

1. A computer-implemented method of managing collaboration in an enterprise application, comprising:
creating an annotation, wherein the annotation corresponds to at least a first document and a second document, the first document having a first document format and the second document having a second document format; and
storing the annotation.

2. The computer-implemented method of claim 1, further comprising mapping the annotation to a workflow process.

3. The computer-implemented method of claim 1, further comprising:
allowing a first user to add a first threaded comment to the annotation, wherein the first threaded comment comprises a first comment by the first user; and
allowing a second user to add a second comment to the first threaded comment in the annotation.

4. The computer-implemented method of claim 2, further comprising allowing a second user to add a second threaded comment to the annotation, wherein the second threaded comment comprises a second comment by the second user.

5. The computer-implemented method of claim 1, further comprising:
associating a first threaded comment with the annotation;
creating an other annotation and associating a second threaded comment with the other annotation; and
grouping the annotation and the other annotation based at least in part on the first threaded comment and the second threaded comment.

6. The computer-implemented method of claim 1, further comprising:
allowing a first user to add a first context to the annotation; and
creating a first context identifier associated with at least the annotation, wherein the first context identifier identifies at least the first context.

7. The computer-implemented method of claim 6, further comprising:
allowing a second user to add a second context to the annotation; and
creating a first context identifier associated with the annotation, wherein the first context identifier identifies at least the first context and the second context.

8. The computer-implemented method of claim 1, wherein the annotation comprises a dynamic object.

9. The computer-implemented method of claim 1, further comprising:
allowing a first user to publish at least the annotation; and
responsive to the publishing, allowing a second user to view at least the annotation.

10. The computer-implemented method of claim 9, further comprising:
allowing the first user to unpublish the annotation; and
responsive to the unpublishing, preventing at least the second user from viewing the annotation.

11. The computer-implemented method of claim 1, further comprising:
locking the annotation; and
responsive to the locking, preventing at least one user from accessing the annotation.

12. The computer-implemented method of claim 1, wherein the first document format and the second document format are substantially similar.

13. The computer-implemented method of claim 1, wherein the first document format and the second document format are different.

14. The computer-implemented method of claim 1, wherein the first document is stored in a first document repository and the second document is stored in a second document repository.

15. The computer-implemented method of claim 14, wherein at least one of the first and second document repositories comprises an enterprise backend system.

16. The computer-implemented method of claim 1, further comprising allowing a user to add a tag to the annotation.

17. One or more tangible computer-readable media storing instructions that, when executed by a processor, cause a computer to perform a method comprising:
creating annotations responsive to user input provided by collaborators, wherein at least some of the annotations have threaded comments and at least some of the annotations have context identifiers, wherein each of the context identifiers identify a corresponding context, and wherein at least some of the annotations correspond to documents having a first document format and at least some of the annotations correspond to documents having a second document format;
allowing at least some of the collaborators to view at least some of the annotations;
allowing at least some of the collaborators to search the annotations by applying queries to at least some of the annotations; and
allowing at least some of the collaborators to apply filters to at least some of the annotations.

18. The one or more tangible computer-readable media of claim 17, wherein the method further comprises grouping the annotations by the threaded comments.

19. The one or more tangible computer-readable media of claim 17, wherein the method further comprises grouping the annotations by the context identifiers.

20. An annotation management system, comprising:
a plurality of document repositories to each store at least one document;
an annotation repository to store a plurality of annotations, wherein each of the annotation references at least one document stored in a corresponding one of the plurality of document repositories; and
an annotation application to:
allow a plurality of collaborators to view at least a sub-plurality of the plurality of annotations;
allow at least one of the collaborators to search the plurality of annotations; and
allow at least one of the collaborators to apply a filter to the plurality of annotations.
